(19) United States
(12) Patent Application Publication
(10) Pub. No.: US 2014/0081926 A1
(43) Pub. Date: Mar. 20, 2014

(54) IMAGE DUPLICATION PREVENTION APPARATUS AND IMAGE DUPLICATION PREVENTION METHOD

(71) Applicant: Canon Europa N.V., Amstelveen (NL)

(72) Inventors: Matthew ADAMS, Cambridge (GB); Simon EVANS, Worthing (GB)

(73) Assignee: Canon Europa N.V., Amstelveen (NL)

(21) Appl. No.: 14/023,881

(22) Filed: Sep. 11, 2013

(30) Foreign Application Priority Data
Sep. 14, 2012 (GB) 1216421.6

(51) Int. Cl. G06F 17/30

(52) U.S. Cl. CPC G06F 17/30244
USPC 707/692

(57) ABSTRACT

An image duplication prevention apparatus comprising: image duplication prevention means for, when a determining means of the image duplication prevention apparatus determines that a subset of metadata of an image to be transferred from a first location to a second location is identical to a corresponding subset of metadata of any image already stored at the second location, preventing the transfer of the image from the first location to the second location. The image duplication prevention means is further for, when the determining means determines that the subset of metadata of the image to be transferred is not identical to the corresponding subset of metadata of the any image already stored at the second location, allowing the transfer of the image from the first location to the second location.

### CROSS-REFERENCE TO RELATED APPLICATIONS

The present application claims priority from United Kingdom patent application no. 1216421.6 filed on 14 Sep. 2012.

### BACKGROUND OF THE INVENTION

1. Field of the Invention

The present invention relates to an image duplication prevention apparatus and an image duplication prevention method. In particular, the present invention relates to a technique of facilitating image storage management.

2. Background of the Invention

With recent spread of digital cameras and recent broadband networking of the Internet, a user can easily acquire many images by, for example, capturing an image from a digital camera, receiving an image attached to E-mail from a friend, downloading a still picture or moving picture from a Web page or uploading a still picture or moving picture from a Web page to a server. Thus, the user must manage many images received via many different channels.

Duplicate images can take up a lot of space on a user's hard drive. Also some image uploading tools fail to identify and delete duplicate images resulting in duplicate images being unnecessarily uploaded to a server (e.g. image-sharing sites) which causes unnecessary usage of resources such as storage and bandwidth.

### SUMMARY OF THE INVENTION

The present invention recognizes that it is desirable to provide an image duplication prevention apparatus and an image duplication prevention method that effectively prevents duplicate images from being stored in a user's hard drive or uploaded to a server.

It is an object of the present invention to provide an image duplication prevention apparatus and an image duplication prevention method that effectively prevents duplicate images from being stored in a user's hard drive or uploaded to a server.

According to a first aspect of the present invention there is provided an image duplication prevention apparatus comprising:
detecting means for detecting whether an image is to be transferred from a first location to a second location;
extracting means for, when the detecting means has detected that the image is to be transferred from the first location to the second location, extracting a subset of metadata from predetermined fields of metadata belonging to the image to be transferred;
comparing means for comparing the subset of metadata of the image to be transferred with a corresponding subset of metadata of each of any image which is already stored at the second location, which corresponding subset of metadata is extracted from fields of metadata corresponding to the predetermined fields of the metadata of the image to be transferred;
determining means for, when the comparing means compares the subset of metadata of the image to be transferred with the corresponding subset of metadata of each of the any image which is already stored at the second location, determining whether the subset of metadata of the image to be transferred is identical to the corresponding subset of metadata of the any image already stored at the second location; and
image duplication prevention means for, when the determining means determines that the subset of metadata of the image to be transferred is identical to the corresponding subset of metadata of the any image already stored at the second location, preventing the transfer of the image from the first location to the second location;
   wherein the image duplication prevention means is further for, when the determining means determines that the subset of metadata of the image to be transferred is not identical to the corresponding subset of metadata of the any image already stored at the second location, allowing the transfer of the image from the first location to the second location.

Preventing image duplication by comparing a subset of metadata of an image to be transferred from a first location to a second location with a corresponding subset of metadata of each of any image which is already stored at the second location provides a number of advantages. Firstly, even if the image files which are being compared are in different formats, e.g. TIFF and JPEG, the present invention will recognize two essentially different files as identical. This will lead to a more reliable image duplication prevention implementation compared to other image duplication prevention implementations which use the images themselves as the basis for the comparison operation. Such other image duplication prevention implementations may not identify identical images in different image formats as identical images. Secondly, because the present invention uses a subset of metadata of the image to be transferred, less processing resources are required compared to a case where entire metadata of an image or entire image data are used in the comparison operation, resulting in a more efficient operation. Preferably, the predetermined fields of the metadata of the image to be transferred comprise: make and model of a capturing apparatus used to capture the image to be transferred, and timestamp of the image to be transferred, which timestamp includes the date and time of when the image to be transferred was captured by the capturing apparatus. More preferably, the predetermined fields of the metadata of the image to be transferred consist of: make and model of a capturing apparatus used to capture the image to be transferred, and timestamp of the image to be transferred, which timestamp includes the date and time of when the image to be transferred was captured by the capturing apparatus. It has been advantageously found that using metadata containing the make and model of the capturing apparatus and the timestamp of when the image was captured leads to more reliable/consistent identification of duplicate images.

Preferably, the extraction means comprises hash generation means for generating a hash from the subset of metadata from the predetermined fields of metadata belonging to the image to be transferred; wherein the comparing means is configured to compare the hash of the subset of metadata of the image to be transferred with a hash of the corresponding subset of metadata of each of the any image which is already stored at the second location; wherein the determining means is configured, when the comparing means compares the hash of the subset of metadata of the image to be transferred with the hash of the corresponding subset of metadata of each of the any image which is already stored at the second location, to determine whether the hash of the subset of metadata of the image to be transferred is identical to the hash of the corresponding subset of metadata of the any image already stored at the second location; wherein the image duplication prevention means is configured, when the determining means determines that the hash of the subset of metadata of the image to be transferred is identical to the hash of the corresponding subset of metadata of the any image already stored at the second location, to prevent the transfer of the image from the first location to the second location; and wherein the image duplication prevention means is further configured, when the determining means determines that the hash of the subset of metadata of the image to be transferred is not identical to the hash of the corresponding subset of metadata of the any image already stored at the second location, to allow the transfer of the image from the first location to the second location.

Preferably, the hash function used is based on the SHA-2 algorithm. More preferably, the hash function used is SHA-256.

According to a second aspect of the present invention there is provided an image duplication prevention method comprising: detecting whether an image is to be transferred from a first location to a second location; extracting, when the detecting step detects that the image is to be transferred from the first location to the second location, a subset of metadata from predetermined fields of metadata belonging to the image to be transferred; comparing the subset of metadata of the image to be transferred with a corresponding subset of metadata of each of any image which is already stored at the second location, which corresponding subset of metadata is extracted from fields of metadata corresponding to the predetermined fields of the metadata of the image to be transferred; determining, when the comparing step compares the subset of metadata of the image to be transferred with the corresponding subset of metadata of each of the any image which is already stored at the second location, whether the subset of metadata of the image to be transferred is identical to the corresponding subset of metadata of the any image already stored at the second location; and in a case that the determining step determines that the subset of metadata of the image to be transferred is identical to the corresponding subset of metadata of the any image already stored at the second location, preventing the transfer of the image from the first location to the second location; and in a case that the determining step determines that the subset of metadata of the image to be transferred is not identical to the corresponding subset of metadata of the any image already stored at the second location, allowing the transfer of the image from the first location to the second location.

### BRIEF DESCRIPTION OF THE DRAWINGS

Embodiments of the present invention will now be described, by way of example only, with reference to the accompanying figures in which:

FIG. 1 shows the configuration of an image processing apparatus of the first embodiment;

FIG. 2 shows an example of the structure of metadata of a captured image;

FIG. 3 is a flowchart showing an image duplication prevention process according to the first embodiment;

FIG. 4 shows architecture of the second embodiment;

FIG. 5 shows the configuration of an image processing apparatus of the second embodiment;

FIG. 6 is a flowchart showing an image duplication prevention process according to the second embodiment;

### DESCRIPTION OF THE EMBODIMENTS

### First Embodiment

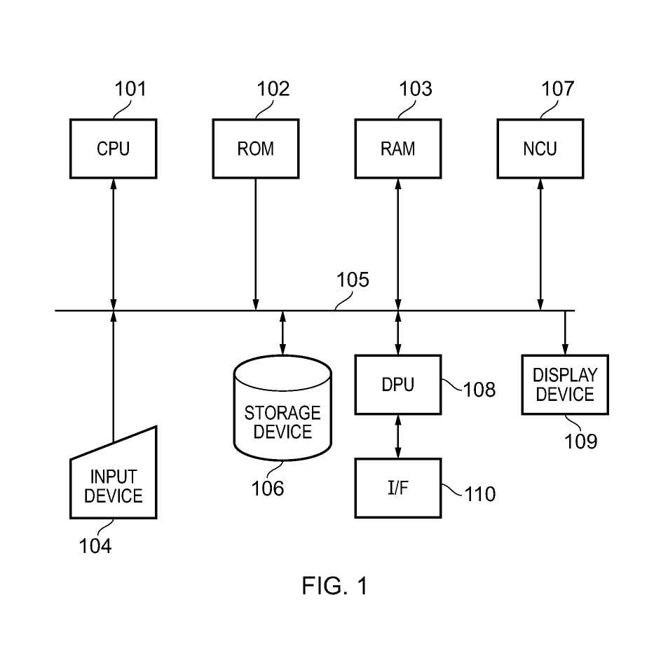

FIG. 1 illustrates a configuration of a PC 10 (personal computer) which can implement an image processing apparatus according to the present invention. A central processing unit (CPU) 101 executes various types of controls in the PC 10. The processing described below is controlled by the CPU 101. Contents of an operation are instructed by a program in a read only memory (ROM) 102 or a random access memory (RAM) 103. The CPU 101 can perform a plurality of processing programs in parallel, by a function of the CPU 101 itself or by a mechanism of the processing programs. The ROM 102 stores the processing programs and data which store a control procedure to be performed by the CPU 101.

The RAM 103 stores a control program to be processed by the CPU 101 and provides a work area for various pieces of data when the CPU 101 executes various types of controls. An input device 104 includes a keyboard and a mouse which provides a user with an operating environment for various types of inputs. Other types of input device 104 can be provided for various types of inputs, including any of a touch panel, a stylus pen, and the like. A bus 105 includes an address bus or a data bus and is connected to each unit in the configuration.

A storage device 106 stores various pieces of data. The storage device 106 may include a recording medium, such as a hard disk, a floppy disk, an optical disk, a magnetic disk, a magneto-optical disk, a magnetic tape, and a non-volatile memory card, and a drive for driving the recording medium and recording information in it. The processing programs and data that are stored are entirely or partially called onto the RAM 103 when necessary as a result of instructions input via the input device 104 and those from various processing programs. The storage device 106 saves programs and data for causing an OS (Operating System) or the CPU 101 to execute processes (to be described later) to be performed by the PC 10.

A communication device network control unit (NCU) 107 is used to communicate with other computer apparatuses. The NCU 107 communicates with an apparatus located in a remote area (e.g. a server) via the network (local area network (LAN) or the like, e.g. a Wi-Fi network), so that the programs and data pieces of the present exemplary embodiment can be shared with the remote computer apparatus. As a communication method between the computer apparatuses, wired communications including, for example, a recommended standard 232C (RS232C), a universal serial bus (USB), institute of electrical and electronic engineers (IEEE) 1394, P1284, a small computer system interface (SCSI), a modem, and Ethernet (registered trademark), and wireless communications including, for example, Bluetooth, an infrared communication, and IEEE802.11b may be used. In other words, any communication method can be used as long as it includes a communication unit communicating with a device connected to the display control apparatus according to the present invention.

An image duplication prevention unit (DPU) 108 performs processing for determining, when receiving images from an external device such as a camera or a mobile phone, whether an image has been previously stored in the storage device 106. The DPU 108 compares a hash of metadata of the image to be received with a hash of metadata of each image already stored in the storage device. If there is a hash collision, which indicates two identical images, then the transfer of the image, which is the subject of the hash collision, will not be permitted and an error will be displayed on the display device 109 and/or on the display of the external device (e.g. camera or mobile phone) with details of the already stored image. In this case, the display may present the user with an option to override the DPU 108 so that the transfer is allowed to go ahead. Alternatively, after the hash collision is identified, the transfer of the image which is the subject of the hash collision with an already stored image may be permitted but a message is displayed to the user via the display 109 and/or the display of the external device that one of the two identical images will be deleted after the transfer. In this embodiment, the hash function used is based on the SHA-2 algorithm and can be any of SHA-224, SHA-256, SHA-384, SHA-512. However, any other hashing algorithm such as MD5, SHA-0, SHA-1, SHA-3 can also be used. In FIG. 1, the DPU 108 is shown as a distinct unit from the CPU 101 which communicates with the CPU 101 via the bus 105. However, the DPU 108 may alternatively be implemented as a program run by the CPU 101.

The display device 109 includes a display and is able to display states of various input operations and processing results according to the states on the display screen to the user. The display can be formed of an LCD (liquid crystal display), a PDP (plasma display panel), an OLED (organic light-emitting diode), or the like, and can display with images and text the results of various processes performed by the CPU 101. Reference numeral 110 denotes an I/F (InterFace) which connects an external device such as a digital camera or a mobile phone. The DPU 108 and the CPU 101 read and execute the program code stored in the ROM 102 and the ROM 103, so that the function of the apparatus can be realized.

The storage device 106 can store a program and data relating to the present invention and the program can be copied from the storage device to the rewritable recording medium such as the RAM 103.

The data used for image data duplication prevention according to the present invention may be obtained via the NCU 107 (as will be explained in relation to the second embodiment) as well as from the storage device 106. Similarly, the data created during the duplication processing may be stored on another device via the NCU 107 as well as on one or more of the ROM 102, the RAM 103, and the storage device 106. The configuration described above is merely an example of the present exemplary embodiment and the present invention is not limited thereto.

Processes to be performed by the PC 10 having the above arrangement will be explained.

Images are saved in the storage device 106. One or more folders for saving images can be created in advance of the image transfer in the storage device 106 or the images can be saved in a default folder (e.g. My Pictures folder in Microsoft Windows®) on the storage device 106.

In this embodiment, a digital camera is connected to the I/F 110, and an image captured by the digital camera is received into the storage device 106. The storage process is controlled by the CPU 101 and the DPU 108.

In the following description, a method of designating one or more folders for saving images, a method of storing an image in the storage device 106 and a method of creating a folder are not particularly limited.

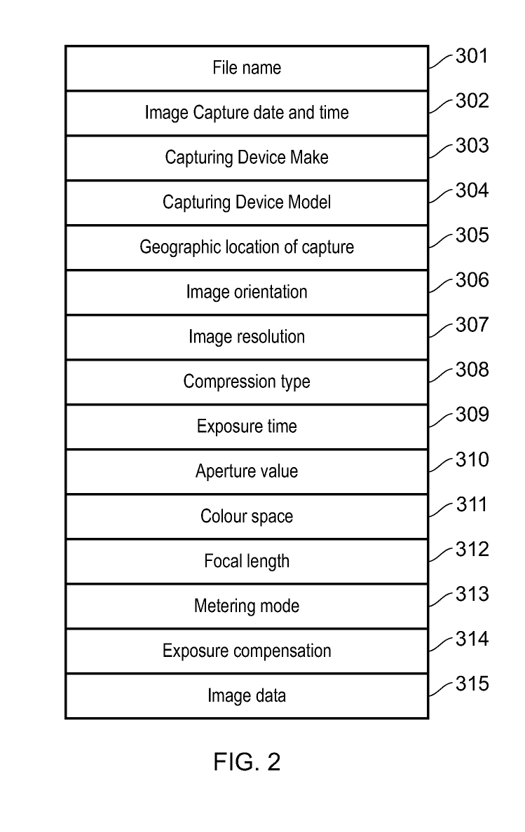

FIG. 2 is a view showing an example of the structure of metadata of a captured image. As is well known, metadata such as the file name 301, image capture date & time 302 (timestamp), the make 303, the model 304 of the capturing device, geographic location of capture 305, image orientation 306, image resolution 307, compression type 308, exposure time 309, aperture value 310, colour space 311, focal length 312, metering mode 313, exposure compensation 314, etc. are attached to or associated/stored with an image data body 315 when an image is captured by a capturing device (e.g. digital camera or mobile phone). The metadata in the image data is transferred along with the image to the computer. The metadata is in a particular format such as EXIF (Exchangeable image file format).

Each image data 305 is stored together with its metadata when the image is transferred to the computer. Note that the structure of the image data is not limited to the one shown in FIG. 2.

### Image Transfer Process

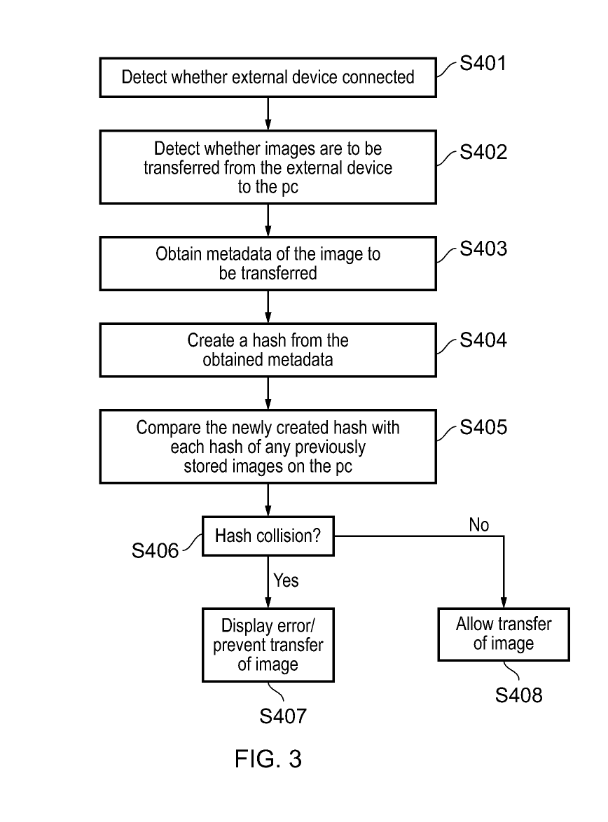

Processes to be performed by the image processing apparatus having the above arrangement will be explained next with reference to FIG. 3.

In step S401, the DPU 108 detects whether an external device such as a digital camera is connected to the I/F 110. In step S402, after the DPU 108 has detected that the digital camera is connected, the DPU 108 detects whether images are to be transferred from the digital camera to the computer. In step S403, after the DPU 108 has detected that images are to be transferred from the digital camera to the computer, the DPU 108 obtains metadata of an image to be transferred. In step S404, the DPU 108 creates a hash from selected/designated fields of the metadata using the hash function SHA-256. In this embodiment, the selected/designated fields are make, model and timestamp, for example the above fields could comprise the following metadata: Canon, Canon Digital IXUS 220 HS, 2012:01:17 17:35:20. The metadata of the selected/designated fields is then hashed using a hash function such as SHA-256. In step S405, the DPU 108 compares the newly created hash of the metadata of the image to be transferred with a hash of metadata of each of any images previously stored in the PC 10. In step S406, if the DPU 108 determines that there is a hash collision which indicates that an image to be received from the digital camera is substantially identical to an image already stored on the PC 10, then the transfer of the image which is the subject of the hash collision will not be permitted by the DPU 108 and an error will be displayed on the display device 109 and/or on the display of the external device (e.g. camera or mobile phone) with details of the already stored image (S407). In this case, the display may present the user with an option to override the DPU 108 so that the transfer is allowed to go ahead.

Alternatively, after the hash collision is identified, the transfer of the image which is the subject of the hash collision with an already stored image may be permitted but a message is displayed to the user via the display 109 and/or the display of the external device that one of the two identical images will be deleted after the transfer. If no hash collision exists, which indicates that the image to be received from the digital camera is not substantially identical to any image already stored on the PC 10, then the DPU 108 transmits a response to the PC 10 (i.e. CPU 101) to commence transfer of the image. Of course, if there are a plurality of images to be transferred, then the DPU 108 may perform image duplication prevention processing for all of the images to be transferred before transmitting a response to the PC 10 with details of any images to be transferred which are duplicates of images already stored on the PC 10. Once the PC 10 has received a response from the DPU 108, it commences transferring images to the PC 10 which have not been identified as duplicates.

### Second Embodiment

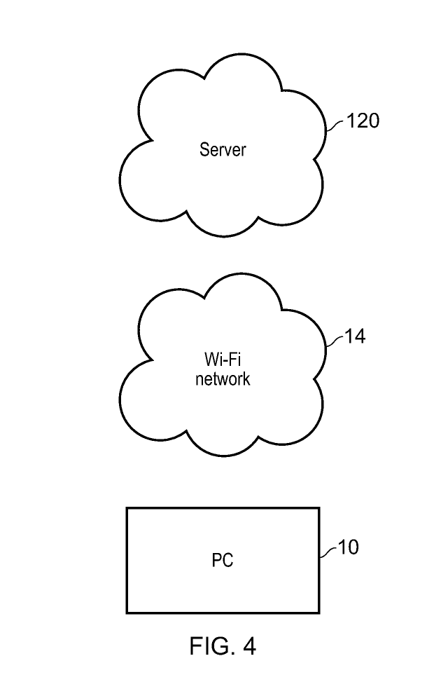

FIG. 4 shows architecture of an image-processing system of the second embodiment. The image-processing system comprises the PC 10 and a server 120. The PC 10 is able to connect to the internet via a Wi-Fi network 14 so as to access the server 120.

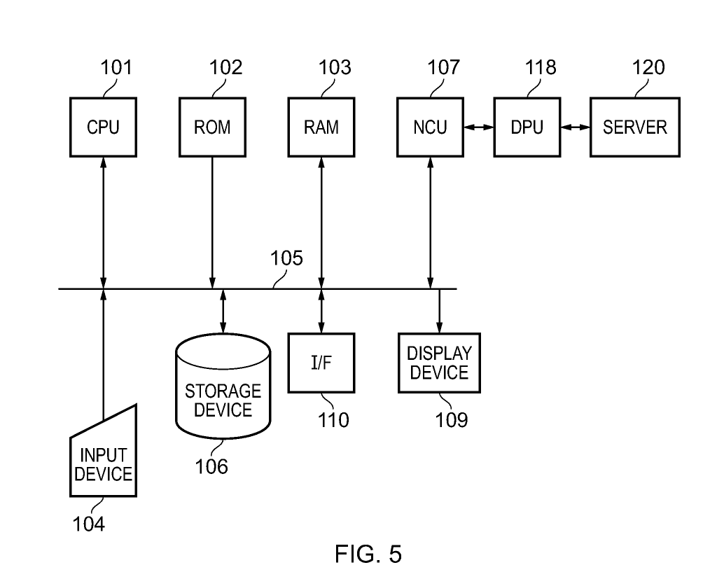

FIG. 5 illustrates a configuration of an image processing system according to an exemplary embodiment of the present invention. Descriptions of structures and processes identical to those in the first embodiment shall be omitted. For example, a detailed description of the hardware identified by reference numerals 101, 102, 103, 104, 105, 106, 107, 109 and 110 described in relation to FIG. 1 of the first embodiment and the structure of metadata of a captured image described in relation to FIG. 2 of the first embodiment will not be repeated.

An image duplication prevention unit (DPU) 118 performs processing for determining, when transferring images to the server 120 (e.g. hosting an image-sharing site), whether an image stored on the computer has been previously uploaded to the server 120. In FIG. 5, the DPU 118 is shown as a distinct unit from the PC 10 and the server 120. However, the DPU 118 may form a part of the PC 10 and/or a part of the server 120. For example, the DPU 118 may be implemented as a program run by the PC 10 and/or the server 120.

The DPU 118 compares a hash of metadata of the image to be uploaded with a hash of metadata of each of any image already uploaded to the server 120. For example, the hash of metadata of the image to be uploaded could be generated by a part of the DPU 118 at the client side and the generated hash is then transferred to a part of the DPU 118 residing at the server side which compares the received hash with the hash of metadata of any image already uploaded to the server 120. If no hash collision exists, which indicates that the image to be uploaded is not substantially identical to any image already uploaded to the server 120, then the part of the DPU 118 residing at the server 120 transmits a response to the DPU 118 residing at the client side informing the client (PC 10) to commence upload of the image.

If there is a hash collision, which indicates that the image to be uploaded is substantially identical to an image already uploaded to the server 120, then the transfer of the image which is the subject of the hash collision will not be permitted and an error will be displayed on the display device 109 and/or on the display of the remote external storage device (e.g. server 120) with details of the already stored image. In this case, the display may present the user with an option to override the DPU 118 so that the transfer is allowed to go ahead. Of course, if there are a plurality of images to be uploaded, then the DPU 118 may perform image duplication prevention processing for all of the images to be uploaded before transmitting a response to the PC 10 with details of any images to be uploaded which are duplicates of images already uploaded to the server. Once the PC 10 has received a response from the server 120, it commences uploading of images to the server 120 which have not been identified as duplicates. Alternatively, after the hash collision is identified, the transfer of the image which is the subject of the hash collision with an already uploaded image may be permitted but a message is displayed to the user via the display 109 and/or the display of the external device that one of the two identical images will be deleted after the transfer. In this embodiment, the hash function used is based on the SHA-2 algorithm and can be any of SHA-224, SHA-256, SHA-384, SHA-512. However, any other suitable hashing algorithm such as MD5, SHA-0, SHA-1, SHA-3 may also be used.

### Image Transfer Process

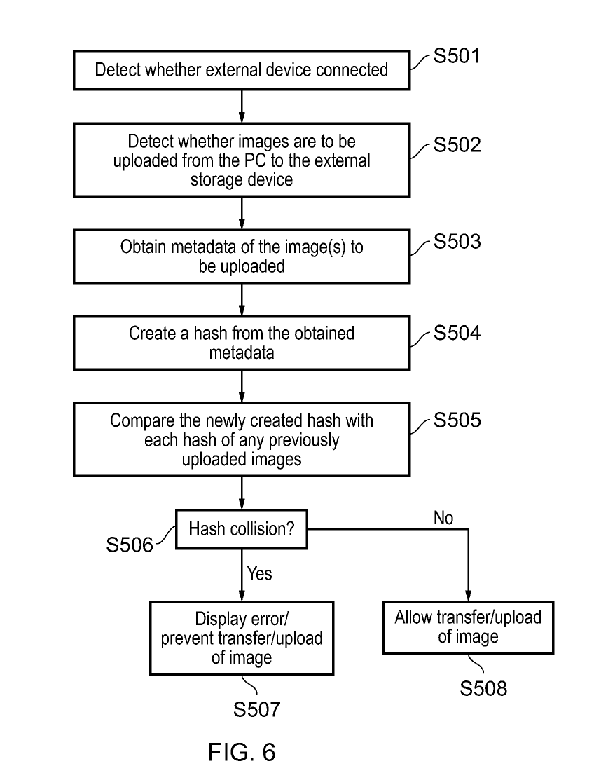

Processes to be performed by the image processing system having the above arrangement will be explained next with reference to FIG. 6.

In step S501, the DPU 118 detects whether an external storage device such as the server 120 is connected to the NCU 107. In step S502, after the DPU 118 has detected that the server 120 is connected, the DPU 118 detects whether images are to be uploaded from the computer to the server 120. In step S503, after the DPU 118 has detected that images are to be uploaded from the computer to the server 120, the DPU 118 obtains metadata of an image to be uploaded. In step S504, the DPU 118 creates a hash from selected/designated fields of the metadata of the image using the hash function SHA-256. In this embodiment, the selected/designated fields are make, model and timestamp, for example the above fields could comprise the following metadata: Canon, Canon Digital IXUS 220 HS, 2012:01:17 17:35:20. The metadata of the selected/designated fields is then hashed using a hash function such as SHA-256. In step S505, the DPU 118 compares the newly created hash of the metadata of the image to be uploaded with each of any existing hashes of metadata of images previously uploaded to the server 120. In step S506, if the DPU 118 determines that there is a hash collision which indicates that the image to be uploaded is substantially identical to an image already uploaded to the server 102, then the upload of the image which is the subject of the hash collision will not be permitted by the DPU 118 and an error will be displayed on the display device 109 and/or on the display of the server 120 with details of the already uploaded image (see S507). In this case, the display may present the user with an option to override the DPU 118 so that the upload is allowed to go ahead. Alternatively, after the hash collision is identified, the upload of the image which is the subject of the hash collision with an already uploaded image may be permitted but a message is displayed to the user via the display 109 and/or the display of the server 120 that one of the two identical images will be deleted after the upload. If no hash collision exists, which indicates that the image to be uploaded is not substantially identical to any image already uploaded to the server 120, then the part of the DPU 118 residing at the server 120 transmits a response to the DPU 118 residing at the client side informing the client (PC 10) to commence upload of the image (see S508). Of course, if there are a plurality of images to be uploaded, then the DPU 118 may perform image duplication prevention processing for all of the images to be uploaded before transmitting a response to the PC 10 with details of any images to be uploaded which are duplicates of images already uploaded to the server. Once the PC 10 has received a response from the server 120, it commences uploading of images to the server 120 which have not been identified as duplicates.

Embodiments of the present invention have been described above. Further embodiments of the present invention can also be realized by apparatuses or systems that read out and execute programs recorded on a memory device to perform the functions of the above-described embodiment(s), and by a method, the steps of which are performed by, for example, reading out and executing a program recorded on a memory device to perform the functions of the above-described embodiment(s). For this purpose, the program may be provided to the image processing apparatus or image processing system, for example via a network or from a recording medium of various types serving as the memory device (e.g., computer-readable medium).

1. An image duplication prevention apparatus comprising:
a detecting unit configured to detect whether an image is to be transferred from a first location to a second location;
an extracting unit configured to, when the detecting unit has detected that the image is to be transferred from the first location to the second location, extract a subset of metadata from predetermined fields of metadata belonging to the image to be transferred;
a comparing unit configured to compare the subset of metadata of the image to be transferred with a corresponding subset of metadata of each of any image which is already stored at the second location, which corresponding subset of metadata is extracted from fields of metadata corresponding to the predetermined fields of the metadata of the image to be transferred;
a determining unit configured to, when the comparing unit compares the subset of metadata of the image to be transferred with the corresponding subset of metadata of each of the any image which is already stored at the second location, determine whether the subset of metadata of the image to be transferred is identical to the corresponding subset of metadata of the any image already stored at the second location; and
an image duplication prevention unit configured to, when the determining unit determines that the subset of metadata of the image to be transferred is identical to the corresponding subset of metadata of the any image already stored at the second location, prevent the transfer of the image from the first location to the second location;
wherein the image duplication prevention unit is further configured to, when the determining unit determines that the subset of metadata of the image to be transferred is not identical to the corresponding subset of metadata of the any image already stored at the second location, allow the transfer of the image from the first location to the second location; and
wherein the predetermined fields of the metadata of the image to be transferred consist of: make and model of a capturing apparatus used to capture the image to be transferred, and timestamp of the image to be transferred, which timestamp includes the date and time of when the image to be transferred was captured by the capturing apparatus.

2. The image duplication prevention apparatus according to claim 1, wherein the extraction unit comprises a hash generation unit configured to generate a hash from the subset of metadata from the predetermined fields of metadata belonging to the image to be transferred; wherein the comparing unit is configured to compare the hash of the subset of metadata of the image to be transferred with a hash of the corresponding subset of metadata of each of the any image which is already stored at the second location;
wherein the determining unit is configured, when the comparing unit compares the hash of the subset of metadata of the image to be transferred with the hash of the corresponding subset of metadata of each of the any image which is already stored at the second location, to determine whether the hash of the subset of metadata of the image to be transferred is identical to the hash of the corresponding subset of metadata of the any image already stored at the second location;
wherein the image duplication prevention unit is configured, when the determining unit determines that the hash of the subset of metadata of the image to be transferred is identical to the hash of the corresponding subset of metadata of the any image already stored at the second location, to prevent the transfer of the image from the first location to the second location; and
wherein the image duplication prevention unit is further configured, when the determining unit determines that the hash of the subset of metadata of the image to be transferred is not identical to the hash of the corresponding subset of metadata of the any image already stored at the second location, to allow the transfer of the image from the first location to the second location.

3. The image duplication prevention apparatus according to claim 1, further comprising a displaying unit configured to display, when the image duplication prevention unit prevents the transfer of the image from the first location to the second location, a message at the first location and/or at the second location.

4. The image duplication prevention apparatus according to claim 3, further comprising a user overriding unit configured to allow a user to override the image duplication prevention unit so that the transfer of the image from the first location to the second location is allowed to go ahead.

5. The image duplication prevention apparatus according to claim 1, wherein the first location is a first folder and the second location is a second folder.

6. The image duplication prevention apparatus according to claim 5, wherein the first folder is located on a first device and the second folder is located on a second device.

7. The image duplication prevention apparatus according to claim 1, wherein the first location is an image capturing apparatus and the second location is a personal computer.

8. The image duplication prevention apparatus according to claim 1, wherein the first location is a client device and the second location is a server.

9. The image duplication prevention apparatus according to claim 2, wherein the first location is a client device and the second location is a server and wherein the client device comprises the extracting unit including the hash generation unit, and the server comprises the comparing unit, the determining unit and image duplication prevention unit, wherein the client device is configured to send the generated hash of the subset of metadata of the image to be transferred to the server, and wherein the server is configured, when it receives the generated hash of the subset of metadata of the image to be transferred from the client device, to send a response to the client device comprising information on whether the client device is permitted to send the image to the server.

10. An image duplication prevention method comprising: detecting whether an image is to be transferred from a first location to a second location;
extracting, when the detecting step detects that the image is to be transferred from the first location to the second location, a subset of metadata from predetermined fields of metadata belonging to the image to be transferred;
comparing the subset of metadata of the image to be transferred with a corresponding subset of metadata of each of any image which is already stored at the second location, which corresponding subset of metadata is extracted from fields of metadata corresponding to the predetermined fields of the metadata of the image to be transferred;
determining, when the comparing step compares the subset of metadata of the image to be transferred with the corresponding subset of metadata of each of the any image which is already stored at the second location, whether the subset of metadata of the image to be transferred is identical to the corresponding subset of metadata of the any image already stored at the second location; and
in a case that the determining step determines that the subset of metadata of the image to be transferred is identical to the corresponding subset of metadata of the any image already stored at the second location, preventing the transfer of the image from the first location to the second location; and
in a case that the determining step determines that the subset of metadata of the image to be transferred is not identical to the corresponding subset of metadata of the any image already stored at the second location, allowing the transfer of the image from the first location to the second location;
wherein the predetermined fields of the metadata of the image to be transferred consist of: make and model of a capturing apparatus used to capture the image to be transferred, and timestamp of the image to be transferred, which timestamp includes the date and time of when the image to be transferred was captured by the capturing apparatus.

11. A non-transitory computer-readable storage medium storing a program to cause a computer to perform an image duplication prevention method comprising:
detecting whether an image is to be transferred from a first location to a second location;
extracting, when the detecting step detects that the image is to be transferred from the first location to the second location, a subset of metadata from predetermined fields of metadata belonging to the image to be transferred;
comparing the subset of metadata of the image to be transferred with a corresponding subset of metadata of each of any image which is already stored at the second location, which corresponding subset of metadata is extracted from fields of metadata corresponding to the predetermined fields of the metadata of the image to be transferred;
determining, when the comparing step compares the subset of metadata of the image to be transferred with the corresponding subset of metadata of each of the any image which is already stored at the second location, whether the subset of metadata of the image to be transferred is identical to the corresponding subset of metadata of the any image already stored at the second location; and
in a case that the determining step determines that the subset of metadata of the image to be transferred is identical to the corresponding subset of metadata of the any image already stored at the second location, preventing the transfer of the image from the first location to the second location; and
in a case that the determining step determines that the subset of metadata of the image to be transferred is not identical to the corresponding subset of metadata of the any image already stored at the second location, allowing the transfer of the image from the first location to the second location;
wherein the predetermined fields of the metadata of the image to be transferred consist of: make and model of a capturing apparatus used to capture the image to be transferred, and timestamp of the image to be transferred, which timestamp includes the date and time of when the image to be transferred was captured by the capturing apparatus.
